(19) United States
(12) Patent Application Publication
(10) Pub. No.: US 2016/0147788 A1
(43) Pub. Date: May 26, 2016

(54) PRE-SYNCHRONIZATION ANALYSIS BETWEEN LOCAL DOCUMENTS AND AN ONLINE DOCUMENT MANAGEMENT SYSTEM

(71) Applicant: Ricoh Americas Holdings, West Caldwell, NJ (US)

(72) Inventor: Christopher Ables, Coral Springs, FL (US)

(73) Assignee: RICOH COMPANY, LTD., Tokyo (JP)

(21) Appl. No.: 14/548,652

(22) Filed: Nov. 20, 2014

(51) Int. Cl. G06F 17/30

(52) U.S. Cl. CPC G06F 17/30174

(57) ABSTRACT

Embodiments describe pre-synchronization analysis between a computing device and an online document management system. In one embodiment, the computing device identifies a mapping between a local folder and a remote folder at the system, identifies a local file in the local folder, and determines if a remote copy of the local file exists in the remote folder. When the remote copy does not exist, the computing device adds a pending upload entry in an analysis log. When the remote copy does exist, the computing device either adds a pending upload entry in the analysis log or skips an entry in the analysis log for the local file depending on whether the remote copy was modified after a previous synchronization, the local file was modified after the remote copy, and the local file and the remote copy have different file sizes. The computing device displays the analysis log to a user.

### FIELD OF THE INVENTION

The invention relates to the field of online document management, and in particular, to analyzing a synchronization process between clients and an online document management system.

### BACKGROUND

An online document management system allows users to store, access, and manage their documents remotely in the cloud. In addition to basic storage and retrieval services, the document management system may provide additional services to users such as the creation of custom document types, the assignment of metadata for documents, indexing of documents, Optical Character Recognition (OCR) services for documents, version control for documents, etc.

A client computer will typically utilize a replication service to upload files from the client computer to the document management system, and to download files from the document management system to the client computer. This synchronization process may occur periodically (e.g., once per hour). When an upload replication process occurs at the client, documents modified at the client since the last replication along with new documents created at the client are uploaded to the document management system. When a download replication process occurs, documents modified at the document management system along with new documents created at the document management system are downloaded to the client. However, it may be desirable to provide some information to a user prior to the actual synchronization process. For example, a user may have inadvertently edited or deleted a file, which may not be discoverable until after a synchronization process has occurred.

### SUMMARY

Embodiments described herein provide pre-synchronization analysis between a client and the document management system. Prior to a synchronization process, a modification time and a size of a document are analyzed to determine whether the file will be synchronized between the client and the document management system. The analysis can inform a user about which files, if any, will be synchronized when the synchronization process between the client and the document management system occurs.

In one embodiment, a processor of a computing device is configured to identify a mapping between a local folder of the computing device and a remote folder of an online document management system, to identify a local file in the local folder, and to determine if a remote copy of the local file exists in the remote folder. The processor is further configured, when the remote copy does not exist, to add an entry in an analysis log marking the local file as pending for upload to the remote folder. The processor is further configured, when the remote copy does exist in the remote folder, to determine if the local copy was modified after a previous synchronization, to determine if the local file was modified after the remote copy, and to determine if the local file and the remote copy have different file sizes. The processor is further configured to add an entry in the analysis log marking the local file as pending for upload to the remote folder when the remote copy was modified after the previous synchronization, the local file was modified after the remote copy, and the local file and the remote copy have different file sizes. The processor is further configured to skip an entry in the analysis log for the local file when the remote copy was not modified after the previous synchronization, the local file was not modified after the remote copy, or the local file and the remote copy do not have different file sizes. The processor is further configured to display the analysis log to a user.

Another embodiment is a method of pre-synchronization analysis between a client and an online document management system. The method comprises identifying a mapping between a local folder of a computing device and a remote folder of an online document management system, identifying a local file in the local folder, and determining if a remote copy of the local file exists in the remote folder. The method further comprises adding, when the remote copy does not exist, an entry in an analysis log marking the local file as pending for upload to the remote folder. The method further comprises performing, when the remote copy does exist, the steps of: determining if the local copy was modified after the previous synchronization, determining if the local file was modified after the remote copy, and determining if the local file and the remote copy have different file sizes. The method further comprises performing, when the remote copy does exist, the steps of adding an entry in the analysis log marking the local file as pending for upload to the remote folder when the remote copy was modified after the previous synchronization, the local file was modified after the remote copy, and the local file and the remote copy have different file sizes or skipping an entry in the analysis log for the local file when the remote copy was not modified after the previous synchronization, the local file was not modified after the remote copy, or the local file and the remote copy do not have different file sizes. The method further comprises displaying the analysis log to a user.

Another embodiment is a non-transitory computer readable medium embodying instructions which, when executed by a processor of a computing device, direct the processor to identify a mapping between a local folder of the computing device and a remote folder of an online document management system, to identify a local file in the local folder, and to determine if a remote copy of the local file exists in the remote folder. The instructions further direct the processor to add, when the remote copy does not exist, an entry in an analysis log marking the local file as pending for upload to the remote folder. The instructions further direct the processor, when the remote copy does exist, to determine if the local copy was modified after a previous synchronization, to determine if the local file was modified after the remote copy, and to determine if the local file and the remote copy have different file sizes. The instructions further direct the processor to add an entry in the analysis log marking the local file as pending for upload to the remote folder when the remote copy was modified after the previous synchronization, the local file was modified after the remote copy, and the local file and the remote copy have different file sizes, or to skip an entry in the analysis log for the local file when the remote copy was not modified after the previous synchronization, the local file was not modified after the remote copy, or the local file and the remote copy do not have different file sizes. The instructions further direct the processor to display the analysis log to a user.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of a document collaboration system in an exemplary embodiment.

FIG. 2 is a block diagram of the computing device of FIG. 1 in an exemplary embodiment.

FIG. 3 is a flowchart illustrating a method of pre-synchronization analysis for an upload process from a computing device to an online document management system in an exemplary embodiment.

FIG. 4 is a flowchart illustrating a method of pre-synchronization analysis for a download process from an online document management system to a computing device in an exemplary embodiment.

FIG. 5 is a block diagram of another document collaboration system in an exemplary embodiment.

FIG. 6 illustrates an example of an analysis log.

FIG. 7 is a block diagram of a processing system configured to execute programmed instructions to perform desired functions in an exemplary embodiment.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

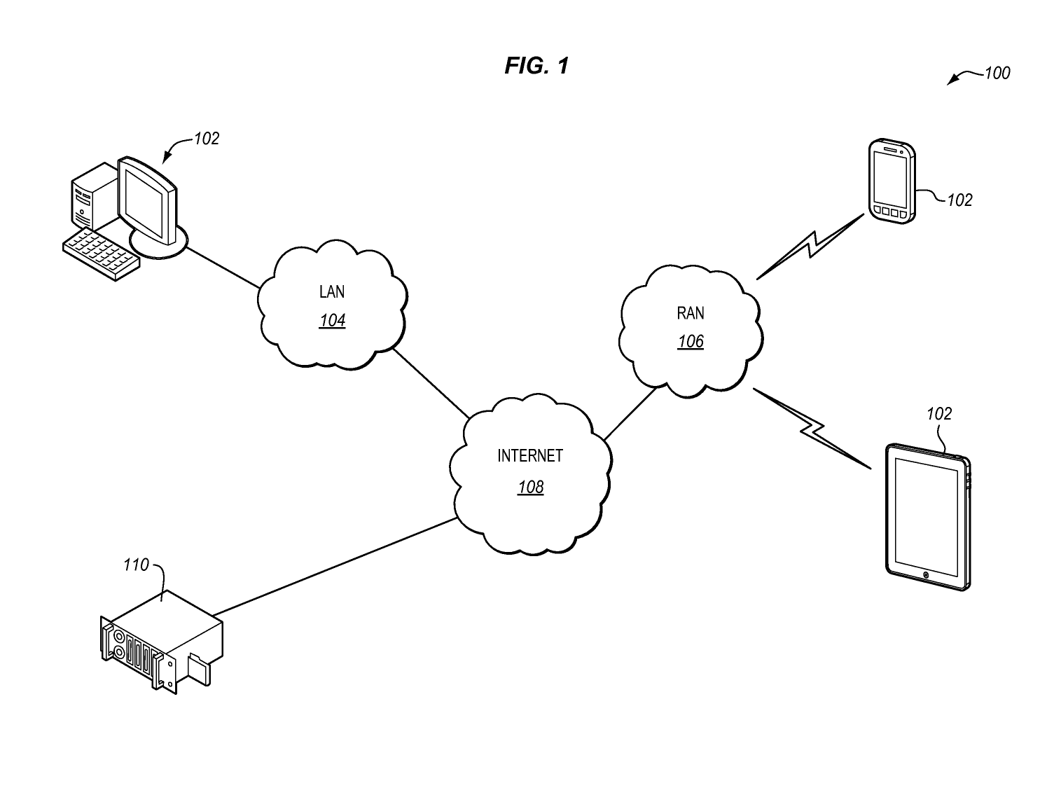

FIG. 1 is a block diagram of a document collaboration system 100 in an exemplary embodiment. In this embodiment, system 100 includes an online document management system 110, which is coupled to the Internet 108 to allow computing devices 102 to participate in a collaborative document environment. In this embodiment, document management system 110 includes any component, system, or device that is able to remotely store and manage documents for computing devices 102. For example, document management system 110 may include one or more file servers that allow computing devices 102 to upload files to document management system 110, download files from document management system 110, check out files, lock files, etc. Document management system 110 may also be referred to as a cloud storage system or an online file management system and/or service.

In this embodiment, three computing devices 102 are illustrated, although the implementation of system 100 may include more or fewer computing devices 102 as an implementation choice. Also, system 100 is not necessarily limited to the particular computing devices 102 illustrated in FIG. 1. In FIG. 1, one of computing devices 102 comprises a computer, which is coupled to Internet 108 utilizing a Local Area Network (LAN) 104. One example of LAN 104 is Ethernet. Also in FIG, 1, another of computing devices 102 comprises a smartphone, which is coupled to Internet 108 using a Radio Access Network (RAN) 106. Some examples of RAN 106 include Wi-Fi networks, cellular networks such as a Global System for Mobile Communications (GSM) network, a Code Division Multiple Access (CDMA) network, etc. Another one of computing devices 102 comprises a tablet computer, which also couples to Internet 108 using RAN 106.

In this embodiment, computing devices 102 comprise any component, system, or device that are able to provide a pre-synchronization analysis between computing devices 102 and document management system 110. For example, a computer may synchronize locally stored files with document management system 110 via LAN 104 and Internet 108 to allow a user of the computer (not shown) to collaborate with other users (e.g., users of the smart phone and/or the tablet). In like manner, the smart phone may synchronize locally stored files with document management system 110 via RAN 106 and Internet 108 to allow a user of the smart phone (not shown) to collaborate with other users (e.g., users of the computer and/or the tablet). The tablet may synchronize locally files with document management system 110 via RAN 106 and Internet 108 to allow a user of the tablet (not shown) to collaborate with other users (e.g., users of the computer and/or the smartphone). In this embodiment, computing devices 102 are capable of providing an analysis to a user of which, if any, files will be synchronized between client devices 102 and document management system 110.

One problem with a synchronization process is that the user may be unaware of what will occur during the next synchronization until the synchronization has already been completed. For example, if a user accidentally modified a local document, then the user may be unaware that the local document may be uploaded to document management system 110 and potentially distributed to multiple users. In like manner, if a user had accidentally deleted a local document, then the user may be unaware that the local document may be deleted from document management system 110.

In the embodiments described, computing devices 102 are able to perform a pre-synchronization analysis and determine if the file (either locally or remotely) will either be uploaded to document management system 110 or downloaded from document management system 110. This information allows a user to potentially correct inadvertent edits, deletions, etc., before a synchronization process actually uploads files to document management system 110 or downloads files from document management system 110.

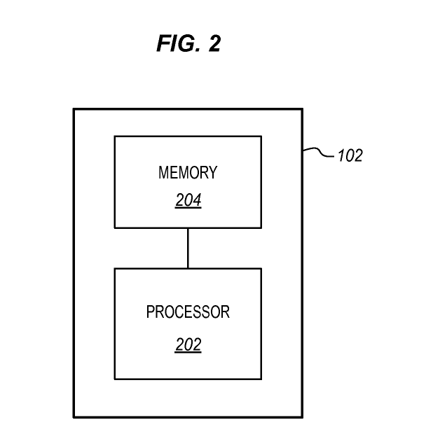

FIG. 2 is a block diagram of computing devices 102 of FIG. 1 in an exemplary embodiment. In this embodiment, computing devices 102 include a processor 202 and a memory 204. Processor 202 includes any hardware device that is able to perform functions. Processor 202 may include one or more Central Processing Units (CPU), microprocessors, Digital Signal Processors (DSPs), Application-specific Integrated Circuits (ASICs), etc. Some examples of processors include Intel® Core™ processors, Advanced Risk Machines (ARM®) processors, etc.

Memory 204 includes any hardware device that is able to store data. For instance, memory 204 may store local copies of files downloaded from document management system 110, to allow a user to review and/or modify the local files. Memory 204 may also store files created by a user that have not yet been synchronized with document management system 110. For example, a user may create a new file using a word processing application, and store the file in memory 206 during an edit process for the file. Memory 206 may include one or more volatile or non-volatile Dynamic Random Access Memory (DRAM) devices, FLASH devices, volatile or non-volatile Static RAM devices, hard drives, Solid State Disks (SSDs), etc. Some examples of non-volatile DRAM and SRAM include battery-backed DRAM and battery-backed SRAM.

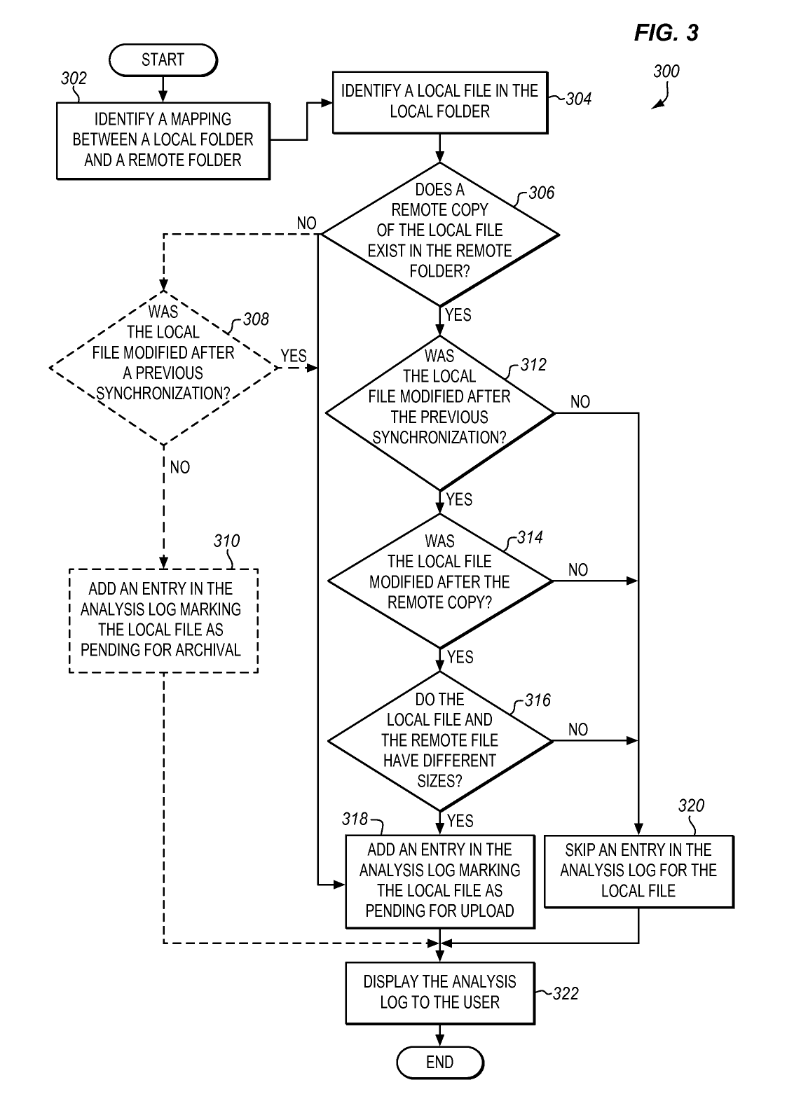

For this embodiment, assume that computing devices 102 have access to document management system 110, and participate in an online document collaboration environment. FIG. 3 is a flowchart illustrating a method of pre-synchronization analysis for an upload process from a computing device to an online document management system in an exemplary embodiment.

The steps of method 300 will be described with reference to FIGS. 1-2, but those skilled in the art will appreciate that method 300 may be performed in other systems. The steps of the flowchart(s) described herein are not all inclusive and may include other steps not shown. The steps described herein may also be performed in an alternative order. Generally, method 300 is performed by computing devices 102 whenever a user desires to collect information about which, if any, files will be synchronized between computing devices 102 and document management system 110. Method 300 may be performed automatically prior to allowing a synchronization process to occur, may be performed periodically (e.g., once per hour, at a particular time per day, upon saving a local copy of a file, etc.), or may occur on demand (e.g., a manual analysis triggered by a user).

Processor 202 identifies a mapping between a local folder of computing device 102 and a remote folder of document management system 110 (see step 302 of FIG. 3). The mapping may be pre-determined by a user to allow the user to participate in the document collaboration process with other users. For instance, a user may create a local folder at computing device 102 called “finance”, and map the local folder to a remote folder called “finance project” stored at document management system 110. This allows the user to synchronize files stored in the local folder with the remote folder.

Processor 202 identifies a local file stored in the local folder (see step 304). For instance, a user may drag and drop a file into the local folder, the user may have previously downloaded a file from document management system 110 to the local folder, etc. Processor 202 determines if a remote copy of the local file exists in the remote folder (step 306). If document management system 110 includes an Application Programming Interface (API) that allows computing device 102 to list the contents of files stored in the remote folder, then an API query may be generated by computing device 102 and transmitted to document management system 110 for a file list or other information that identifies the files or documents stored at the remote folder. If a remote copy does not exist in the remote folder, then processor 202 adds an entry in an analysis log marking the local file as pending for upload to the remote folder (see step 318).

If a remote copy of the local file does exist in the remote folder, then processor 202 will determine if the local file was modified after the previous synchronization (see step 312). The local file may not be modified after the previous synchronization if a file is not being actively edited by a user of computing device 102. In this case, it would be unnecessary to upload the local file to document management system 110 because no changes have been made to the local file since the previous synchronization. Processor 202 will skip an entry in the analysis log for the local file (see step 320). When a user reviews the analysis log, the user will be able to determine that the local file will not be uploaded to the remote folder.

If however the local file had changed since the previous synchronization, then processor 202 determines if the local file was modified after the remote copy (see step 314). To do so, processor 202 may generate an API request for document management system 110 regarding the remote copy. The API request allows document management system 110 to return timestamp information about the remote copy that can be used by processor 202 to determine if the local file was modified after the remote copy. If the local file was not modified after the remote copy, then processor 202 will skip an entry in the analysis log for the local file (see step 320). When a user reviews the analysis log, the user will be able to determine that the local file will not be uploaded to the remote folder.

If the local file was modified after the remote copy, then processor 202 determines if the local file and the remote copy have different sizes (see step 316). In some cases, a file is opened and no changes are made. When the file is subsequently closed, a timestamp for the file may be modified. By comparing a size of the local file with a size of the remote copy, processor 202 is able to detect this case. To do so, processor 202 may generate an API request for document management system 110 regarding the remote copy. The API request allows document management system 110 to return size information about the remote copy that can be used by processor 202 to determine if the local file is a different size than the remote copy. If the sizes are the same, the processor 202 will skip an entry in the analysis log for the local file (see step 320). When a user reviews the analysis log, the user will be able to determine that the local file will not be uploaded to the remote folder.

If the local file was modified after the previous synchronization, and the local file was modified after the remote copy, and the sizes of the local file and the remote copy are different, then processor 202 will add an entry in the analysis log marking the local file as pending for upload to the remote folder (see step 318). In response to adding an entry in the analysis log for the local file, processor 202 may return to step 304 and identify additional files (if any) in the local folder of computing device 102, and either add or skip entries in the analysis log for any remaining local files in the local folder. Processor 202 then displays the analysis log to the user (see step 322). The analysis log provides the user with information regarding which files, if any, will be uploaded to the remote folder during a subsequent synchronization process.

In an optional embodiment, when the remote copy of the local file does not exist, processor 202 determines if the local file was modified after a previous synchronization (see step 308). Processor 202 may compare the timestamp of the local file with a time when a previous synchronization occurred and determine if the local file has changed since the previous synchronization. This may occur if the user had made changes to the local file after the previous synchronization. If the local file was modified after the previous synchronization, then processor 202 adds an entry in an analysis log marking the local file as pending for upload to the remote folder (see step 318). However, if the local file had not been modified since the previous synchronization, then processor 202 adds an entry in the analysis log marking the local file as pending for archival (see step 310). Archiving the local file removes the local file from the local folder yet retains a copy of the local file for a user in an archive folder. In this case, the remote copy did not exist on document management system 110, and the local file had not changed since the previous synchronization. This may occur when the remote copy stored at document management system 110 is deleted (e.g., deleted by another user). In a collaboration environment, a file may be deleted at document management system 110 if it is no longer needed. The analysis log provides the user with information regarding which files, if any, will be archived during a subsequent synchronization process.

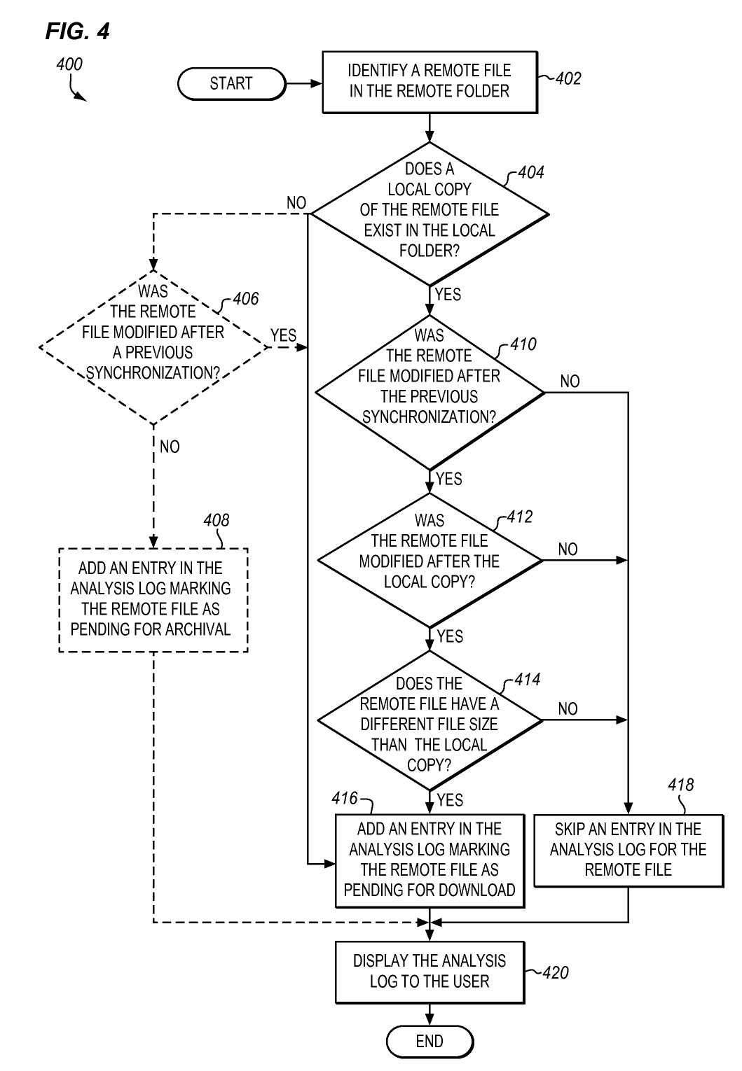

FIG. 4 is a flowchart illustrating a method of pre-synchronization analysis for a download process from an online document management system to a computing device in an exemplary embodiment. The steps of method 400 will be described with reference to FIGS. 1-2, but those skilled in the art will appreciate that method 400 may be performed in other systems. Method 400 may be performed by computing devices 102 in some embodiments in addition to method 300. For instance, after performing an analysis of files that will upload from the local folder on computing device 102 to document management system 110, processor 202 may then perform method 400 to determine if any files in the remote folder will to be downloaded from document management system 110 to computing device 102.

Processor 202 identifies a remote file stored in the remote folder (see step 402). For instance, a user may upload a file to the remote folder, either manually or via a synchronization process. Processor 202 determines if a local copy of the remote file exists on computing device 102 (see step 404). If document management system 110 includes an API that allows computing device 102 to list the contents of files stored in the remote folder, then an API query may be generated by computing device 102 and transmitted to document management system 110 for a file list or other information that identifies the files or documents stored at the remote folder. If a local copy does not exist at computing device 102, then processor 202 adds an entry in an analysis log marking the remote file as pending for download to the local folder (see step 416).

If a local copy of the remote file does exist in the local folder, then processor 202 will determine if the remote file was modified after the previous synchronization (see step 410). The remote file may not be modified after the previous synchronization if a file is not being actively edited by other users of computing devices 102. In this case, it would be unnecessary to download the remote file to computing device 102 because no changes have been made to the remote file since the previous synchronization. Processor 202 will skip an entry in the analysis log for the remote file (see step 418). When a user reviews the analysis log, the user will be able to determine that the remote file will not be downloaded to the local folder on computing device 102.

However, if the remote file had changed since the previous synchronization, then processor 202 determines if the remote file was modified after the local copy (see step 412). To do so, processor 202 may generate an API request for document management system 110 regarding the remote file. The API request allows document management system 110 to return timestamp information about the remote file that can be used by processor 202 to determine if the remote file was modified after the local copy. If the remote file was not modified after the local copy, then processor 202 will skip an entry in the analysis log for the local copy (see step 418). When a user reviews the analysis log, the user will be able to determine that the remote file will not be downloaded to the local folder on computing device 102.

However, if the remote file was modified after the local copy, then processor 202 determines if the remote file and the local copy have different sizes (see step 414). In some cases, a file is opened and no changes are made. When the file is subsequently closed, a timestamp for the file may be modified. By comparing a size of the remote file with a size of the local copy, processor 202 is able to detect this case. To do so, processor 202 may generate an API request for document management system 110 regarding the remote file. The API request allows document management system 110 to return size information about the remote file that can be used by processor 202 to determine if the remote file is a different size than the local copy. If the sizes are the same, the processor 202 will skip an entry in the analysis log for the local file (see step 418). When a user reviews the analysis log, the user will be able to determine that the remote file will not be downloaded to the local folder on computing device 102.

If the remote file was modified after the previous synchronization, and the remote file was modified after the local copy, and the sizes of the remote file and the local copy are different, then processor 202 adds an entry in the analysis log marking the remote file as pending for download to the local folder (see step 416). In response to adding an entry in the analysis log for the remote file, processor 202 may return to step 402 and identify additional files (if any) in the remote folder of document management system 110, and either add or skip entries in the analysis log for any remaining files in the remote folder. Processor 202 then displays the analysis log to the user (see step 420). The analysis log provides the user with information regarding which files, if any, will be downloaded to the local folder during a subsequent synchronization process.

In an optional embodiment, when the local copy of the remote file does not exist, then processor 202 determines if the remote file was modified after a previous synchronization (see step 406). A synchronization process between the remote folder and the local folder may occur periodically, based on a schedule, on demand from a user, etc. Processor 202 may compare the timestamp of the remote file with a time when a previous synchronization occurred and determine if the remote file has changed since the previous synchronization. This may occur if the other users have made changes to the remote file after the previous synchronization. If the remote file has changed, then processor 202 adds an entry in an analysis log marking the remote file as pending for download to the local folder (see step 416). However, if the remote file has not changed since the previous synchronization, then processor 202 adds an entry in the analysis log marking the remote file as pending for archival (see step 408). Archiving the remote file removes the remote file from the remote folder, yet retains a copy of the remote file for users in an archive folder. In this case, the local copy did not exist on computing device 102, and the remote file had not changed since the previous synchronization. This may occur when the remote file stored at document management system 110 is deleted (e.g., deleted by another user). In a collaboration environment, a file may be deleted at document management system 110 if it is no longer needed. The analysis log provides the user with information regarding which files, if any, will be archived during a subsequent synchronization process.

### EXAMPLE

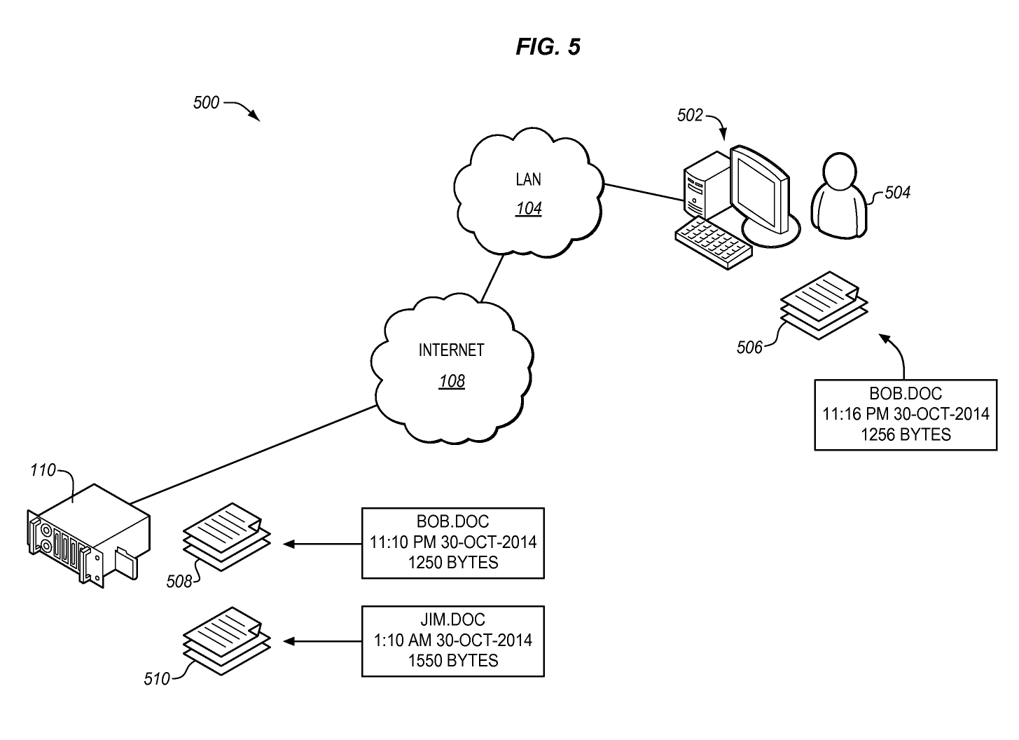

The following example will be discussed with respect to online collaboration system 500 of FIG. 5. The example is not intended to define a preferred embodiment or limit the scope of the claims but rather, is intended to provide one possible implementation of a pre-synchronization analysis between a computing device and an online document management system.

Assume for this embodiment that a synchronization process occurred at computer 502 at 11:00 PM on 30-OCT-2014, and that user 504 initiates an file analysis regarding which, if any, files will be uploaded from computer 502 to document management system 110 from a local folder and which, if any, files will be downloaded from document management system 110 to the local folder of computer 502. Computer 502 identifies a local file 506 in the local folder to process. Local file 506 is named bob.doc, which was last modified at 11:16 PM on 30-OCT-2014 and has a file size of 1256 bytes. Computer 502 determines that a remote copy 508 of bob.doc does exist at document management system 110. In this case, document management system 110 stores a remote copy 508 named bob.doc in the remote folder, which was last modified at 11:10 PM on 30-OCT-2014 and has a files size of 1250 bytes. Computer 502 then determines if local file 506 was modified after the last synchronization. Computer 502 checks the timestamps of the local file 506, and determines that local file 506 was modified after 11:00 PM, which was the last synchronization (e.g., 11:16 PM is later than 11:00 PM). Computer 502 then determines if local file 506 was modified after remote copy 508. Computer 502 compares the timestamps for local file 506 and remote copy 508, and determines that local file 506 was modified after remote copy 508 (e.g., 11:16 PM is later than 11:10 PM). Computer then compares the file sizes of local file 506 and remote copy 508, and determines that they are different (e.g., 1256 bytes is different than 1250 bytes). Based on the determination that remote copy 508 does exist, that local file 506 was modified after the last synchronization, that local file 506 was modified after remote copy 508, and that the file sizes between local file 506 and remote copy are different, computer 502 adds an entry in an analysis log marking local file 506 as pending for upload to document management system 110. A similar process is performed on the remote folder stored by document management system 110, which determines that a remote file 510 named jim.doc is scheduled for download from document management system 110 to computer 502.

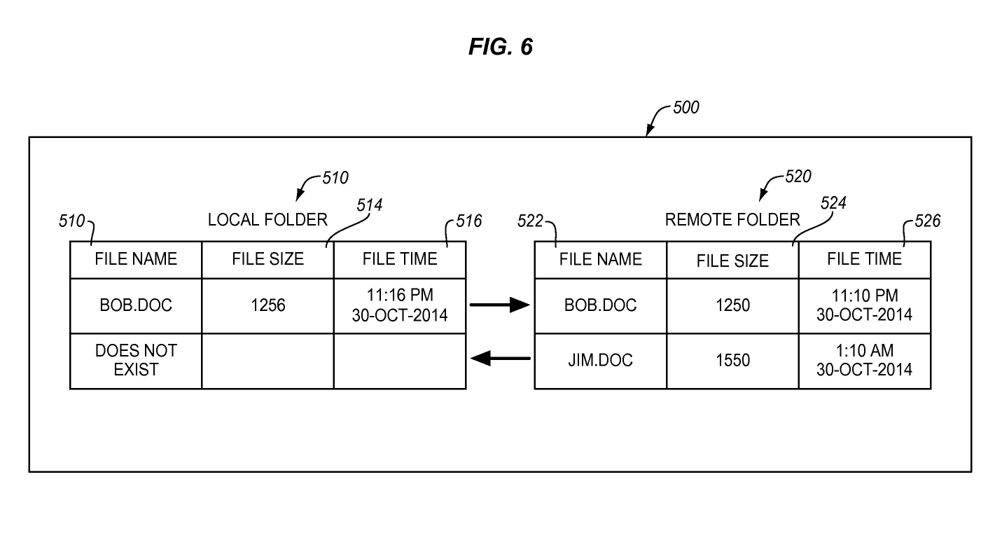

FIG. 6 illustrates an example of an analysis log 500, generated by computer 502 during the analysis of which, if any, files will be uploaded from computer 502 to document management system 110 from the local folder and which, if any, files will be downloaded from document management system 110 to the local folder of computer 502. FIG. 6 illustrates that analysis log 500 for local folder 510 includes a file name field 512, a file size field 514, and a file time field 516. A remote folder 520 in analysis log 500 includes a file name field 522, a file size field 524, and a file time field 526. In the example, bob.doc is scheduled for upload from local folder 510 to remote folder 520 for the next synchronization, and jim.doc is scheduled for downloaded from remote folder 520 to local folder 510 for the next synchronization. Based on analysis log 500, user 504 may review the pending synchronization activities and determine if they should proceed. For instance, analysis log 500 may be presented to user 504 prior to performing the next synchronization process. This allows user 504 to determine if any potential problems exist for files that are scheduled for synchronization.

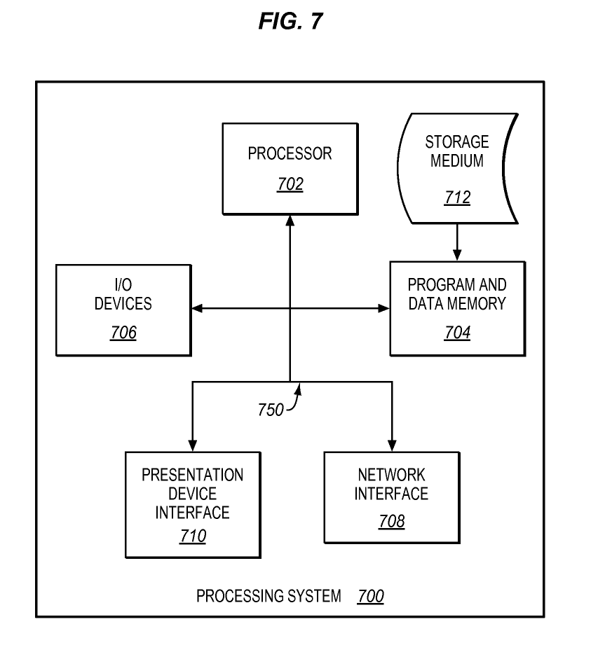

Embodiments disclosed herein can take the form of software, hardware, firmware, or various combinations thereof. FIG. 7 is a block diagram of a processing system configured to execute programmed instructions to perform desired functions in an exemplary embodiment.

Processing system 700 is operable to perform the above operations by executing programmed instructions tangibly embodied on computer readable storage medium 712. In this regard, embodiments of the invention can take the form of a computer program accessible via computer-readable medium 712 providing program code for use by a computer or any other instruction execution system. For the purposes of this description, computer readable storage medium 712 can be anything that can contain or store the program for use by the computer.

Computer readable storage medium 712 can be an electronic, magnetic, optical, electromagnetic, infrared, or semiconductor device. Examples of computer readable storage medium 712 include a solid state memory, a magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

Processing system 700, being suitable for storing and/or executing the program code, includes at least one processor 702 coupled to program and data memory 704 through a system bus 750. Program and data memory 704 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 706 (including but not limited to keyboards, displays, pointing devices, etc.) can be coupled either directly or through intervening I/O controllers. Network adapter interfaces 708 may also be integrated with the system to enable processing system 700 to become coupled to other data processing systems or storage devices through intervening private or public networks. Modems, cable modems, IBM Channel attachments, SCSI, Fibre Channel, and Ethernet cards are just a few of the currently available types of network or host interface adapters. Presentation device interface 710 may be integrated with the system to interface to one or more presentation devices, such as printing systems and displays for presentation of presentation data generated by processor 702.

Although specific embodiments were described herein, the scope of the invention is not limited to those specific embodiments. The scope of the invention is defined by the following claims and any equivalents thereof.

I claim:

1. An apparatus comprising:
a processor of a computing device that is configured to identify a mapping between a local folder of the computing device and a remote folder of an online document management system, to identify a local file in the local folder, and to determine if a remote copy of the local file exists in the remote folder;
the processor is configured, when the remote copy does not exist, and to add an entry in an analysis log marking the local file as pending for upload to the remote folder;
the processor is configured, when the remote copy does exist in the remote folder, to determine if the local copy was modified after a previous synchronization, to determine if the local file was modified after the remote copy, and to determine if the local file and the remote copy have different file sizes, and to:
add an entry in the analysis log marking the local file as pending for upload to the remote folder when the remote copy was modified after the previous synchronization, the local file was modified after the remote copy, and the local file and the remote copy have different file sizes; or
skip an entry in the analysis log for the local file when the remote copy was not modified after the previous synchronization, the local file was not modified after the remote copy, or the local file and the remote copy do not have different file sizes; and
the processor is configured to display the analysis log to a user.

2. The apparatus of claim 1 wherein:
the processor is configured, when the remote copy does not exist, to determine if the local file was modified after the previous synchronization, and to:
add an entry in the analysis log marking the local file as pending for archival when the local file was not modified after the previous synchronization; or
add an entry in the analysis log marking the local file as pending for upload to the remote folder when the local file was modified after the previous synchronization.

3. The apparatus of claim 1 wherein:
the processor is configured to identify a remote file in the remote folder, and to determine if a local copy of the remote file exists in the local folder;
the processor is configured, when the local copy does exist, to determine if the remote file was modified after the previous synchronization, to determine if the remote file was modified after the local copy, and to determine if the remote file and the local copy have different file sizes, and to:
add an entry in the analysis log marking the remote file as pending for download to the local folder when the remote file was modified after the previous synchronization, the remote file was modified after the local copy, and the remote file and the local copy have different file sizes; or
skip an entry in the analysis log for the remote file when the remote file was not modified after the previous synchronization, the remote file was not modified after the local copy, or the remote file and the local copy do not have different file sizes.

4. The apparatus of claim 3 wherein:
the processor is configured, when the local copy does not exist, to determine if the remote file was modified after the previous synchronization, and to:
add an entry in the analysis log marking the remote file as pending for archival when the remote file was not modified after the previous synchronization; or
add an entry in the analysis log marking the remote file as pending for download to the local folder when the remote file was modified after the previous synchronization.

5. The apparatus of claim 1 wherein the processor, to determine if a remote copy of the local file exists in the remote folder, is configured to:
transmit an Application Programming Interface (API) request to the online document management system to identify the files stored in the remote folder, and to compare a response to the API request with a name of the local file to determine if the remote copy of the local file exists in the remote folder.

6. The apparatus of claim 1 wherein the processor, to determine if the local file was modified after the remote copy, is configured to:
transmit an Application Programming Interface (API) request to the online document management system to identify a last modified timestamp for the remote copy, and to compare a response to the API request with a last modified timestamp for the local file to determine if the local file was modified after the remote copy.

7. The apparatus of claim 1 wherein the processor, to determine if the local file and the remote copy have different file sizes, is configured to:
transmit an Application Programming Interface (API) request to the online document management system to identify a file size of the remote copy, and to compare a response to the API request with a file size of the local file to determine if the local file and the remote copy have different file sizes.

8. A method comprising:
identifying a mapping between a local folder of a computing device and a remote folder of an online document management system;
identifying a local file in the local folder;
determining if a remote copy of the local file exists in the remote folder;
adding, when the remote copy does not exist, an entry in an analysis log marking the local file as pending for upload to the remote folder;
performing, when the remote copy does exist, the steps of:
determining if the local copy was modified after a previous synchronization;
determining if the local file was modified after the remote copy;
determining if the local file and the remote copy have different file sizes; and
adding an entry in the analysis log marking the local file as pending for upload to the remote folder when the remote copy was modified after the previous synchronization, the local file was modified after the remote copy, and the local file and the remote copy have different file sizes; or
skipping an entry in the analysis log for the local file when the remote copy was not modified after the previous synchronization, the local file was not modified after the remote copy, or the local file and the remote copy do not have different file sizes; and
displaying the analysis log to a user.

9. The method of claim 8 further comprising:
determining, when the remote copy does not exist, if the local file was modified after the previous synchronization, and performing the steps of:
adding an entry in the analysis log marking the local file as pending for archival when the local file was not modified after the previous synchronization; or
adding an entry in the analysis log marking the local file as pending for upload to the remote folder when the local file was modified after the previous synchronization.

10. The method of claim 8 further comprising:
identifying a remote file in the remote folder;
determining if a local copy of the remote file exists in the local folder;
performing, when the local copy does exist, the steps of:
determining if the remote file was modified after the previous synchronization;
determining if the remote file was modified after the local copy;
determining if the remote file and the local copy have different file sizes; and
adding an entry in the analysis log marking the remote file as pending for download to the local folder when the remote file was modified after the previous synchronization, the remote file was modified after the local copy, and the remote file and the local copy have different file sizes; or
skipping an entry in the analysis log for the remote file when the remote file was not modified after the previous synchronization, the remote file was not modified after the local copy, or the remote file and the local copy do not have different file sizes.

11. The method of claim 10 further comprising:
determining, when the local copy does not exist, if the remote file was modified after the previous synchronization, and performing the steps of:
adding an entry in the analysis log marking the remote file as pending for archival when the remote file was not modified after the previous synchronization; or
adding an entry in the analysis log marking the remote file as pending for download to the local folder when the remote file was modified after the previous synchronization.

12. The method of claim 8 wherein determining if a remote copy of the local file exists in the remote folder comprises:
transmitting an Application Programming Interface (API) request to the online document management system to identify the files stored in the remote folder; and
comparing a response to the API request with a name of the local file to determine if the remote copy of the local file exists in the remote folder.

13. The method of claim 8 wherein determining if the local file was modified after the remote copy comprises:
transmitting an Application Programming Interface (API) request to the online document management system to identify a last modified timestamp for the remote copy; and
comparing a response to the API request with a last modified timestamp for the local file to determine if the local file was modified after the remote copy.

14. The method of claim 8 wherein determining if the local file and the remote copy have different file sizes comprises:
transmitting an Application Programming Interface (API) request to the online document management system to identify a file size of the remote copy; and
comparing a response to the API request with a file size of the local file to determine if the local file and the remote copy have different file sizes.

15. A non-transitory computer readable medium embodying instructions which, when executed by a processor of a computing device, direct the processor to:
identify a mapping between a local folder of the computing device and a remote folder of an online document management system;
identify a local file in the local folder;
determine if a remote copy of the local file exists in the remote folder;
add, when the remote copy does not exist, an entry in an analysis log marking the local file as pending for upload to the remote folder;
perform, when the remote copy does exist, the following:
determine if the local copy was modified after the previous synchronization;
determine if the local file was modified after the remote copy;
determine if the local file and the remote copy have different file sizes; and
add an entry in the analysis log marking the local file as pending for upload to the remote folder when the remote copy was modified after the previous synchronization, the local file was modified after the remote copy, and the local file and the remote copy have different file sizes; or
skip an entry in the analysis log for the local file when the remote copy was not modified after the previous synchronization, the local file was not modified after the remote copy, or the local file and the remote copy do not have different file sizes; and
display the analysis log to a user.

16. The non-transitory computer readable medium of claim 15, wherein the instructions further direct the processor to:
determine, when the remote copy does not exist, if the local file was modified after the previous synchronization, and to:
add an entry in the analysis log marking the local file as pending for archival when the local file was not modified after the previous synchronization; or
add an entry in the analysis log marking the local file as pending for upload to the remote folder when the local file was modified after the previous synchronization.

17. The non-transitory computer readable medium of claim 15, wherein the instructions further direct the processor to:
identify a remote file in the remote folder;
determine if a local copy of the remote file exists in the local folder;
perform, when the local copy does exist, the following:
determine if the remote file was modified after the previous synchronization;
determine if the remote file was modified after the local copy;
determine if the remote file and the local copy have different file sizes; and
add an entry in the analysis log marking the remote file as pending for download to the local folder when the remote file was modified after the previous synchronization, the remote file was modified after the local copy, and the remote file and the local copy have different file sizes; or
skip an entry in the analysis log for the remote file when the remote file was not modified after the previous synchronization, the remote file was not modified after the local copy, or the remote file and the local copy do not have different file sizes.

18. The non-transitory computer readable medium of claim 17, wherein the instructions further direct the processor to:
determine, when the local copy does not exist, if the remote file was modified after a previous synchronization, and to:
add an entry in the analysis log marking the remote file as pending for archival when the remote file was not modified after the previous synchronization; or
add an entry in the analysis log marking the remote file as pending for download to the local folder when the remote file was modified after the previous synchronization.

19. The non-transitory computer readable medium of claim 15, wherein the instructions to determine if a remote copy of the local file exists in the remote folder comprise instructions to:
transmit an Application Programming Interface (API) request to the online document management system to identify the files stored in the remote folder; and
compare a response to the API request with a name of the local file to determine if the remote copy of the local file exists in the remote folder.

20. The non-transitory computer readable medium of claim 15, wherein the instructions to determine if the local file was modified after the remote copy comprise instructions to:
transmit an Application Programming Interface (API) request to the online document management system to identify a last modified timestamp for the remote copy; and
compare a response to the API request with a last modified timestamp for the local file to determine if the local file was modified after the remote copy.
